(19) United States
(12) Patent Application Publication
(10) Pub. No.: US 2026/0110283 A1
(43) Pub. Date: Apr. 23, 2026

(54) Air Intake System Having a Detachable Cover and Window for Viewing and Replacing an Automotive Air Filter

(71) Applicant: Injen Technology Company, Ltd., Montclair, CA (US)

(72) Inventors: Ron Delgado, Montclair, CA (US); Paul Ho, Riverside, CA (US)

(73) Assignee: Injen Technology Company, Ltd., Montclair, CA (US)

(21) Appl. No.: 19/333,175

(22) Filed: Sep. 18, 2025

Related U.S. Application Data
(63) Continuation-in-part of application No. 19/011,190, filed on Jan. 6, 2025.
(63) Continuation of application No. 18/385,053, filed on Oct. 30, 2023, now Pat. No. 12,188,438.

(51) Int. Cl. F02M 35/08; F02M 35/02; F02M 35/024

(52) U.S. Cl. CPC F02M 35/08; F02M 35/0205; F02M 35/024

(57) ABSTRACT

An automobile air intake system that has a detachable airbox cover for accessing an air filter and a transparent window assembly for visually inspecting the air filter is contemplated. A user may inspect the air filter by viewing the air filter through the transparent window assembly. The user may directly access and replace an air filter by removing an airbox cover. The window assembly, airbox cover, and the airbox are releasably secured to each other with magnets and magnetic materials. The airbox has an internal velocity stack for improving engine performance.

### RELATED APPLICATION INFORMATION

The present application is a continuation-in-part of 35 U.S.C. Section 119(e) to U.S. patent application Ser. No. 19/011,190 entitled “Air Intake System Having a Detachable Window for Viewing the Air Filter” filed Jan. 6, 2025 which is a continuation of U.S. patent application Ser. No. 18/385,053 issued as U.S. Pat. No. 12,188,438 on Jan. 7, 2025 entitled “Air Intake System Having a Detachable Window for Viewing the Air Filter” filed Oct. 30, 2023, the disclosures of which are incorporated herein by reference in their entirety.

### BACKGROUND OF THE INVENTION

### 1. Field of the Invention

The present invention relates in general to air intake systems for internal combustion engines. More particularly, the invention is directed to air intake systems for internal combustion engines having detachable covers and detachable transparent windows for inspecting and replacing air filters.

### 2. Description of the Related Art

Aftermarket cold air intake systems may be employed to boost performance for an automobile internal combustion engine. Many air intake systems rely on air filters to trap air contaminants. Air filters need to be visually inspected periodically and replaced as necessary to ensure peak engine performance. Many conventional air intake systems require the air intake systems to be disassembled in order for the user to inspect or replace the air filter. However, the disassembly of the air intake system placed in a tight engine cavity is often time-consuming and challenging.

Accordingly, a need exists to provide an air intake system that facilitates the inspection and replacement of air filters without the need to dissemble the air intake system.

### SUMMARY OF THE INVENTION

In the first aspect, an air intake system for an internal combustion engine is disclosed. The air intake system comprises a cold air intake for receiving cold air, a tube for directing filtered air to an internal combustion engine, an airbox having an airbox aperture. The airbox is adapted to receive and releasably secure an automotive air filter. The airbox is configured to accept cold air from the cold air intake, direct the air though the filter, and provide filtered air through the tube leading to the internal combustion engine. The air intake system further comprises a removable airbox cover having a cover aperture. The removable airbox cover is configured to be received by and releasably attach to the airbox aperture of the airbox. The air intake system further comprises a removable window assembly configured to be received by and releasably attach to the cover aperture of the removable airbox cover.

In a first preferred embodiment, the airbox is adapted to receive the automotive air filter through the airbox aperture. The airbox preferably further comprises an internal velocity stack leading to the tube for directing filtered air to the internal combustion engine. The window assembly preferably further comprises a window housing comprising a window frame and a transparent window, the window frame surrounding the transparent window, and a window assembly magnetic material secured to the window frame.

The removable airbox cover preferably further comprise an a upper airbox cover magnetic material secured proximal to a perimeter of the cover aperture of the airbox cover, wherein the window assembly magnetic material is magnetically attracted to the upper airbox cover magnetic material. The removable airbox cover preferably further comprises a lower airbox magnetic material secured proximal to the perimeter of the removable cover. The airbox preferably further comprises airbox magnetic material secured proximal to the perimeter of the airbox aperture of the airbox, the lower airbox magnetic material of the removable cover is magnetically attracted to the airbox magnetic material of the airbox.

The airbox preferably further comprises an airbox recess surrounding the airbox aperture, the airbox recess is shaped to receive and surround the removable airbox cover such that the outer surface of the removable airbox cover is generally flush with outer surface of the airbox. The removable airbox cover preferably further comprises a cover recess surrounding the cover aperture, the cover recess shaped to receive and surround the removable window assembly such that the outer surface of the removable window assembly is generally flush with the outer surface of the removable airbox cover. The airbox cover aperture is preferably positioned near a top of the airbox cover proximal to the tube for directing filtered air to the internal combustion engine. The removable cover and window assembly are preferably shaped as isosceles triangles having radiused corners. The air intake system is preferably an aftermarket product.

In a second aspect, an air intake system for an internal combustion engine is disclosed. The air intake system comprises a cold air intake for receiving cold air, a tube for directing filtered air to an internal combustion engine, and an airbox having an airbox aperture. The airbox is adapted to receive and releasably secure an automotive air filter. The airbox configured to accept cold air from the cold air intake, direct the air though a filter, and provide filtered air through the tube leading to the internal combustion engine.

In a second preferred embodiment, the air intake system further comprises an airbox aperture trim-piece configured to releasably attach to the air box aperture of the air box, the airbox aperture trim-piece having an opening to receive secondary air and direct the secondary air through the air filter. The air intake system preferably further comprises a removable airbox cover having a cover aperture. The removable airbox cover is configured to be received by and magnetically coupled to the airbox aperture of the airbox. The air intake system preferably further comprises a removable window assembly comprising a window housing having a window frame and a transparent window. The window frame surrounding the transparent window. The removable window assembly is configured to be received by and magnetically coupled to the cover aperture of the removable airbox cover.

In a second preferred embodiment, the airbox is adapted to receive the automotive air filter through the airbox aperture. The airbox further preferably comprises an internal velocity stack leading to the tube for directing filtered air to the internal combustion engine. The airbox further preferably comprises an airbox recess surrounding the airbox aperture, the airbox recess is shaped to receive and surround the removable airbox cover such that the outer surface of the removable airbox cover is generally flush with outer surface of the airbox. The removable airbox cover preferably further comprises a cover recess surrounding the cover aperture, the cover recess shaped to receive and surround the removable window assembly such that the outer surface of the removable window assembly is generally flush with the outer surface of the removable airbox cover. The airbox aperture is preferably positioned near a top of the airbox proximal to the tube for directing filtered air to the internal combustion engine. The air intake system is preferably an aftermarket product.

In a third aspect, an air intake system for an internal combustion engine is disclosed. The air intake system comprises a cold air intake for receiving cold air, a tube for directing filtered air to an internal combustion engine, an airbox having an airbox aperture. The airbox adapted to receive and releasably secure a conically-tapered automotive air filter. The airbox is configured to accept cold air from the cold air intake, direct the air though the filter, and provide filtered air through the tube leading to the internal combustion engine. The air intake system further comprises a removable airbox cover having a cover aperture, the removable airbox cover configured to be received by and releasably attach to the airbox aperture of the airbox. The air intake system further comprises a removable window assembly comprising a window housing having a window frame and a transparent window, the window frame surrounding the transparent window, the removable window assembly configured to be received by and releasably attached to the cover aperture of the removable airbox cover.

The airbox further comprises an internal velocity stack leading to the tube for directing filtered air to the internal combustion engine. The airbox further comprises an airbox recess surrounding the airbox aperture, the airbox recess is shaped to receive and surround the removable airbox cover such that the outer surface of the removable airbox cover is generally flush with the airbox. The removable airbox cover further comprises a cover recess surrounding the cover aperture, the cover recess shaped to receive and surround the removable window assembly such that the outer surface of the removable window assembly is generally flush with the removable airbox cover.

These and other features and advantages of the invention will become more apparent with a description of preferred embodiments in reference to the associated drawings.

### DESCRIPTION OF THE DRAWINGS

FIG. 1 is a perspective view of an air intake system in one or more embodiments.

FIG. 2 is a perspective view of a partially disassembled air intake system showing an airbox assembly, a window assembly, and an air filter.

FIG. 3 is a perspective view of a partially disassembled air intake system showing the airbox assembly and the window assembly.

FIG. 4 is a perspective view of a partially disassembled air intake system showing the shape of the conically tapered contours of the airbox assembly and the window assembly.

FIG. 5 is a side view of the air intake system showing the conically tapered contours of the airbox assembly and the window assembly.

FIG. 6 is a perspective view of the partially disassembled view of the air intake assembly showing detail of the airbox aperture and the filer window assembly.

FIG. 7 is a perspective view of the back surface of the window assembly.

FIG. 8 is a perspective view of the assembled air intake system.

FIG. 9 is a perspective view of an air intake system having a removable cover and a removable window assembly in one or more embodiments.

FIG. 10 is a perspective view of a partially disassembled air intake system receiving an automotive air filter in one or more embodiments.

FIG. 11 is a perspective view of a partially disassembled air intake system showing the removable window assembly detached from the airbox cover.

FIG. 12 is a perspective view of a partially disassembled air intake system showing the removable airbox cover detached from the airbox.

FIG. 13 is a perspective view of the airbox revealing the inner cavity of the airbox.

FIG. 14 is a cross-sectional view of the airbox showing the velocity stack.

FIG. 15 is a perspective view of a dissembled airbox receiving a trim-piece in one or more embodiments.

FIG. 16 is a perspective view of the airbox attached to the trim-piece in one or more embodiments.

### DETAILED DESCRIPTION OF THE PREFERRED EMBODIMENTS

Many car enthusiasts seek to achieve better engine performance of their vehicles. For example, these enthusiasts may install an aftermarket cold air intake systems onto their engines which may improve engine performance in terms of increased horsepower, torque, and fuel efficiency. In addition to enhanced engine performance, the air intake systems cause the cars to emit a unique sound resulting from the cold air rushing into the engines, which many users enjoy. These air intake systems are often custom sized for specific automobiles and can be readily installed by many do-it-yourselfers.

Conventional air intake systems rely on air filters to remove contaminants from the air. Air filters are typically either in the form of Dry Filters, which may have paper or foam elements, or in the form of Oiled Filters which require air to flow through a material that has a thin coating of oil. Both types of filters require frequent inspection to determine whether replacement or cleaning of the filter is necessary to avoid engine performance issues.

Unfortunately, conventional air intake systems do not facilitate the convenient inspection of the air filters. Many conventional air intake systems fully enclose the air filter, which requires the user to disassemble the air intake system. Other air intake systems may employ transparent, permanently affixed windows for viewing the air filters, but these conventional windows often become obstructed as a result of the build-up of air contaminants in the intake systems. In both of these situations, the user must disassemble the air intake system to gain access to the air filter, which is time-consuming and inconvenient.

In an embodiment, an air intake system having a detachable transparent window for visually inspecting the air filter is contemplated. A user may either view the air filter through the transparent window or may easily remove the transparent window from the air intake system for an unobstructed view of the air filter when the transparent window may become opaque and coated with air contaminants.

In a preferred embodiment, the transparent window is releasably secured to the air intake system using magnets. If the window is clean and unobstructed, the user may view the air filter through the window to determine whether replacement or cleaning of the filter is necessary. If, on the other hand, the view through the window is obstructed, the user may simply detach the window from the air intake assembly quickly and without the use of tools. In either situation, the user no longer needs to disassemble the air intake system to visually inspect the air filter.

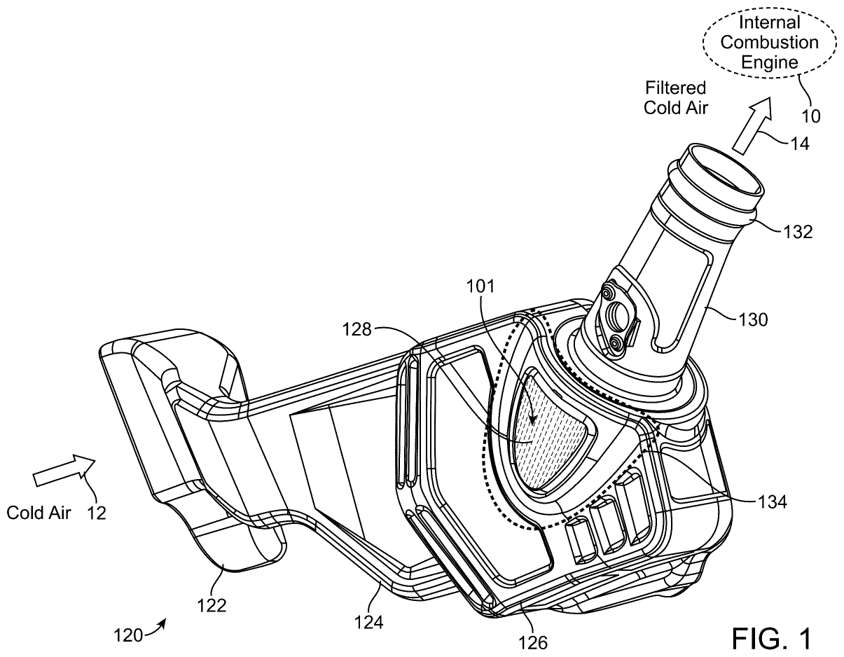

FIG. 1 is a perspective view of an air intake system 120 for an internal combustion engine 10 in one or more embodiments. The air intake system 120 comprises a cold air intake 122 for receiving cold air 12, an intake air duct 124, an airbox 126, a window assembly 101 for inspecting the an filter 128, and a tube 130 for directing the filtered air 14 to an internal combustion engine 10. The cold air intake 122 may be positioned near the grill of a vehicle (not shown), distal from the engine 10, to collect cooler air 12 from outside the vehicle.

Hence, cold air 12 is collected by the cold air intake 122, passes through the cold air intake 122, enters the airbox 126, and then passes through the air filter 128 where the contaminants are removed from the cold air 12. The cold air is routed through the tube 130 where the filtered air 14 is fed into the internal combustion engine 10.

In an embodiment, the air intake system 120 is an aftermarket product that is customized for specific automobiles. The term “aftermarket” refers to products that are non-OEM (“Original Equipment Manufacturer”) that include non-factory accessories and parts that are installed after the sale of the vehicle by the OEM. However, while air intake system 120 which are aftermarket products customized for specific vehicle are illustrated in embodiments described herein, it shall be understood that OEM air intake systems 120 or air intake systems 120 which are designed for multiple vehicles are contemplated in one or more embodiments.

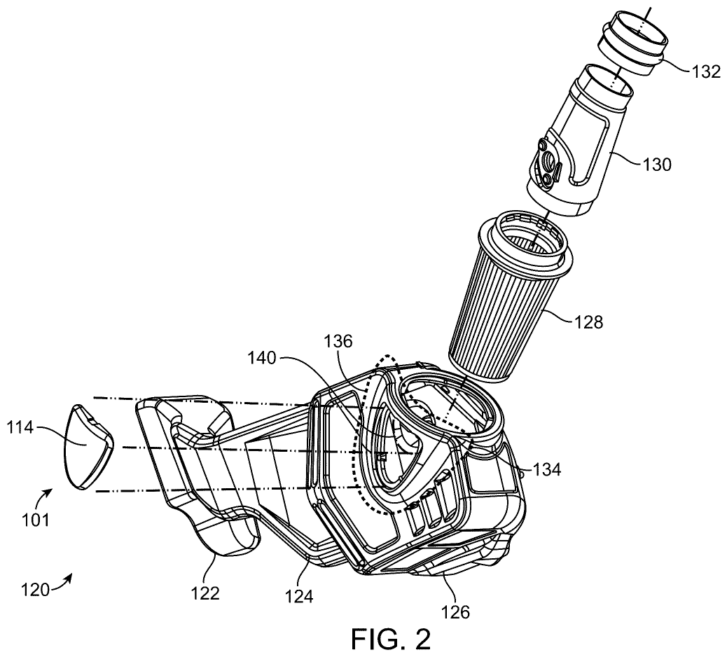

As shown in FIG. 2, airbox 126 has an airbox aperture 140 that receives and mates with the window assembly 101 as discussed in detail below. The airbox 126 is adapted to receive and secure air filter 128. The airbox 126 is configured to accept cold air 12 from the cold air intake 122, direct the air though a filter 128, and provide filtered air 14 through the tube 130 to the internal combustion engine 10. Other components for installing the air intake system 120 into a vehicle and coupling to an engine 10, such as the turbo adapter 132 for coupling the air intake system 120 to the engine 10, are contemplated in one or more embodiments.

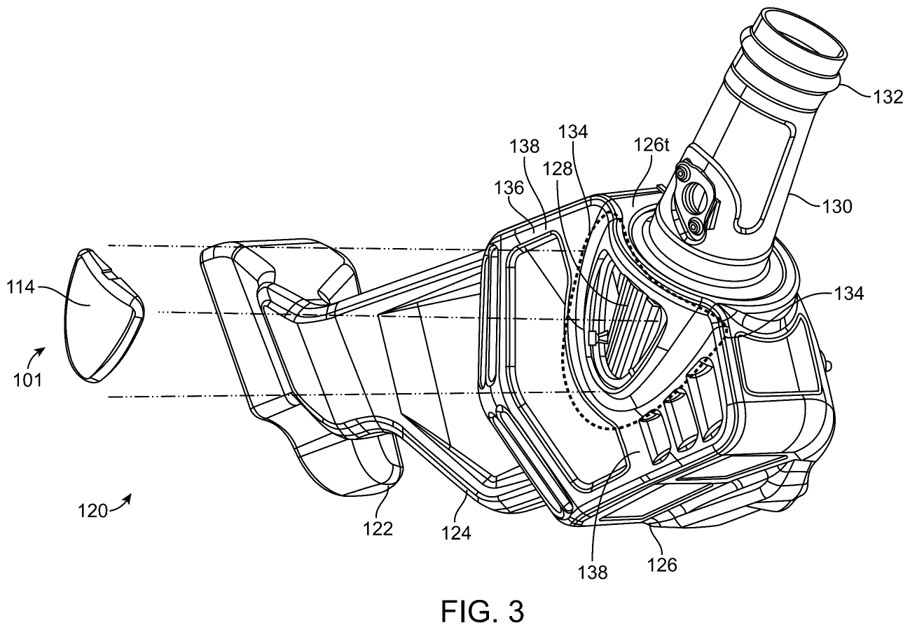

FIG. 3 is a perspective view of a partially disassembled air intake system 120 showing the window assembly 101 removed from the airbox 126. FIGS. 1 and 3 illustrate how a user may inspect the condition of the air filter 128. As shown in FIG. 1, when the window assembly 101 provides an unobstructed view of the filter 128, a user may inspect the filter 128 simply by viewing the filter 128 through the transparent window assembly 101. If, however, the window assembly 101 is obstructed by contaminants, the user may simply remove the window assembly 101 from the airbox 126 by separating the magnetic connections. The user then views the air filter 128 directly and may clean the contaminants from the window assembly 101 before reassembly.

In addition to providing a convenient means for a user to inspect the air filter 128, the air intake system 120 also provides several vehicle performance benefits to the user. First, the engine 10 will exhibit better performance in terms of increased horsepower, torque, and fuel efficiency. Second, embodiments also exhibit the sound of cold air rushing into the combustion chamber of the engine 10 during startup and acceleration exhibited by cold air intake systems. And third, a user may remove the window assembly 101 from the air intake system 120 while racing to obtain better engine 10 performance as a result of increased air flow being fed to the engine 10.

FIGS. 1-4 illustrate that at least a portion 134 of the outer surface 136 the airbox 126 and the outer surface 114 of the window assembly 101 may be contoured around the air filter 128. A contoured airbox 126 and window assembly 101 exposes a greater radial outer surface of the air-filter 128 than would, for example, a flat, non-contoured airbox 126 and window assembly 101. As many air filters 128 are pleated, an enhanced radial view facilitated by one or more embodiments allows the users to inspect multiple pleats of the air filter 128, including inspecting the recesses of multiple pleats. Hence, a properly contoured airbox 126 and window assembly 101 provides the user with an improved view of the air filter 128.

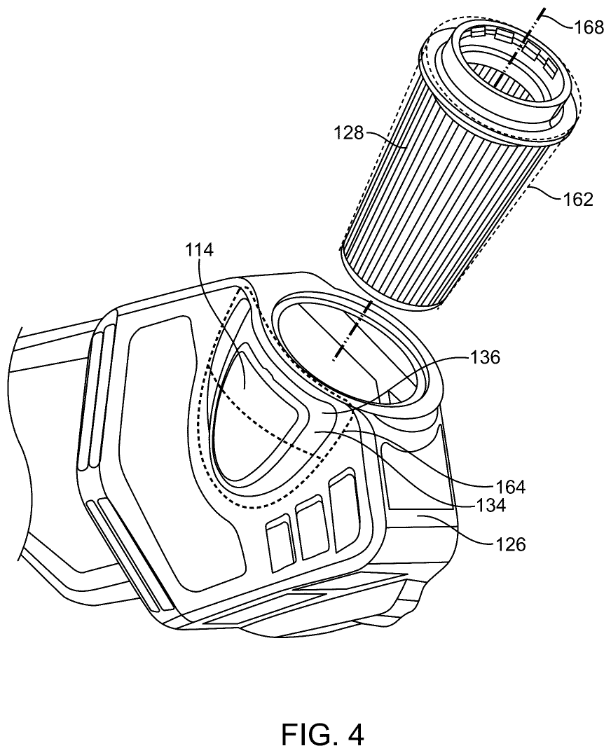

Many commercially available automobile air filters 128 are conically tapered, where the radius from the central axis 168 of an air filter 128 to the outer surface of the filter 128 varies along the axis 168 of the filter 128. In a preferred embodiment, as shown in FIG. 4, the portion 134 of the outer surface 136 of the airbox 126 proximal to the aperture 140 is contoured to form a partial conical taper 164 approximately equidistant from the filter conical taper 162. Likewise, the outer surface 114 is also contoured to form a partial conical taper 164 approximately equidistant from the filter conical taper 162. In an embodiment, the window assembly 101 and the airbox may not be contoured or shaped based on the shape of the air filter.

As shown in FIG. 3, the contour 164 of the outer surface 134 may be formed in a portion 136 of the airbox 126. Outside the contoured portion 136, other surfaces 138 may be formed to address other aspects of the air intake assembly 120, such as shaping the air intake assembly 120 to fit within the engine cavity of the vehicle.

In a preferred embodiment, the airbox aperture 140 (and also the window assembly 101) are positioned proximal to the top of the airbox 126 near the tube 130 for directing filtered air 14 to the internal combustion engine 10. The placement of he aperture 140 and the window assembly 101 exposes the upper portion of the air filter 128 closer to the tube 130 so that a larger area of the filter 128 may be inspected.

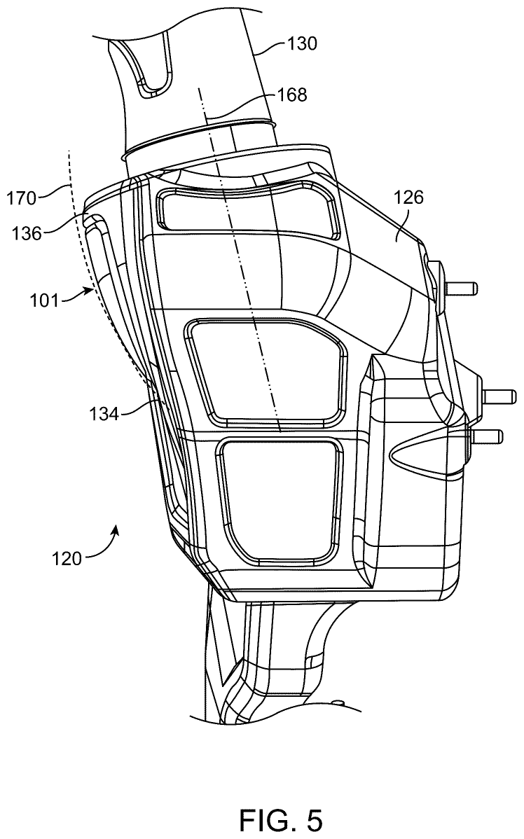

FIG. 5 is a perspective, side view of the air intake system 120 showing the vertical contour taper 170 (i.e., the taper of the window assembly 101 and airbox 126). The vertical contour taper 170 may have a convex taper relative to the axis 168 of the air filter 128. Other vertical contour tapers 170 shapes, such conically tapered with a linear taper or a concave taper, are contemplated in one or more embodiments.

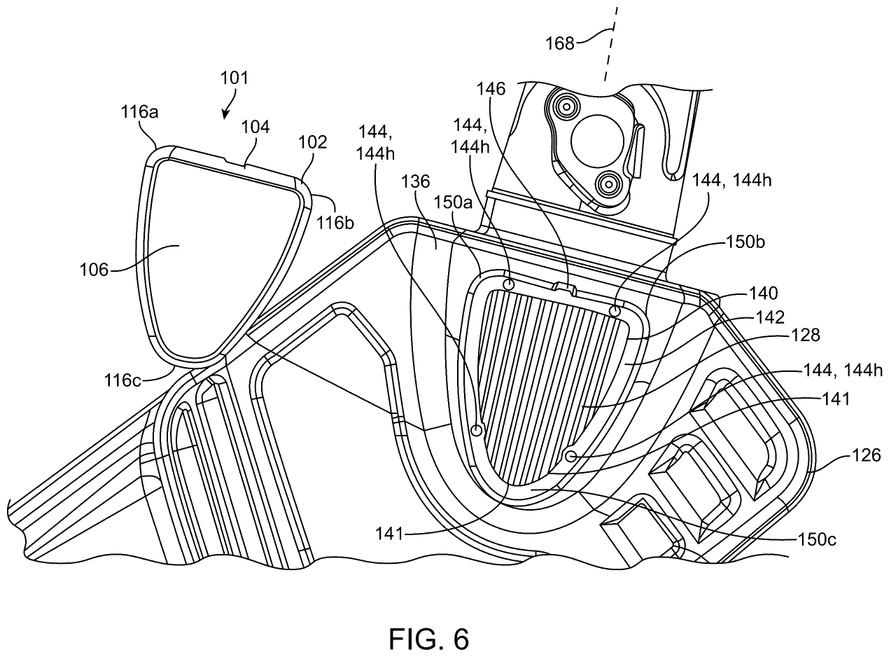

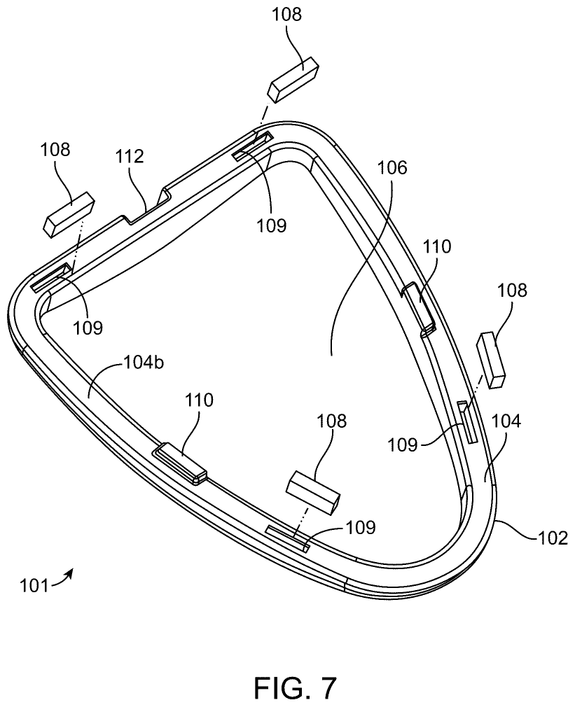

FIGS. 6-7 illustrate details of the window assembly 101 and the region near the aperture 140 on the airbox 126. As shown in FIG. 6, an aperture 140 is formed in the airbox 126 which, as will be discussed below, is sized to receive the window assembly 101. The aperture 126 is shaped as an isosceles triangle having radius corners 150a, 150b, and 150c. The shape of the aperture 140 (as well as the corresponding window assembly 101) may enable the user to attach the window assembly 101 to the airbox 126 more easily, particularly in a cramped engine compartment where the user may have to reattached the window assembly “by feel.” A window notch 112 is formed in the window frame 104 to facilitate the separation of the window assembly 101 to the airbox 126.

Turning attention to the airbox 126, surrounding the perimeter 141 of the aperture 140, a recess 142 is sized and formed in the airbox 126 such that the recess 142 is setback inward from the outer surface 136 of the airbox 126 toward the center axis 168 of the filter 128. Hence, the recess 142 surrounds the aperture perimeter 141 of the airbox aperture 14, where the recess 142 is shaped to receive and surround the window assembly 101 such that the outer surface 114 of the window housing 102 is generally flush with the airbox outer surface 136 of a portion 134 of the airbox 126 proximal to the aperture 140. An aperture notch 146 is formed proximal to the aperture 140 to facilitate the separation of the window assembly 101 to the airbox 126.

Referring to FIGS. 6 and 7, the window assembly 101 comprises a window housing 102 and a plurality of magnets 108 or other magnetic material placed on the bottom of the window assembly in an embodiment. The window housing 102 may be comprised of two components: (1) an opaque outer window frame 104 and (2) a transparent window 106. The window frame 104 surrounds the transparent window 106.

In an embodiment, one or more keyways 110 are formed on the window housing 102, such that the keyways 110 are positioned and shaped to align the window assembly 101 with the airbox aperture 140 as the window assembly 101 is placed onto the airbox 126.

The window assembly 101 may be releasable secured in place to the airbox 126 through fastening means such as by employing magnetized materials such as magnetics and metals. Metal or metal alloys containing iron, cobalt, and nickel for example are attracted to magnetic fields sufficiently strong to be considered magnetic. Magnets are objects that produce a magnetic field that can attract some metal or metal alloys, or attract other magnets.

In an embodiment, a plurality of discrete magnets 108 are placed within the window frame 104 of the window assembly 101. The magnets 108 may be placed in magnet recesses 109 so that the bottom surface 104b of the window frame 104 is flush. Similarly, metal plugs 144 are placed in the recess 142 of the airbox 126 and are positioned to align with and attract the corresponding magnet 108 in the window frame 104. The metal plugs may be placed into holes 144h formed in the recess 142, or may be embedded within the recess 142.

In an embodiment, a first type of magnetic material secured to the window frame 104, and a second type of magnetic material secured proximal to a perimeter 139 of the airbox aperture 140 of the airbox 126. The first type of magnetic material is magnetically attracted to the second type of magnetic material. As can be appreciated, there are various combinations of magnetized materials that can be employed to produce a fastening means through magnetism, such as combinations or metal to magnets, magnet having a North or South pole to another magnet having a South or Noth pole respectively.

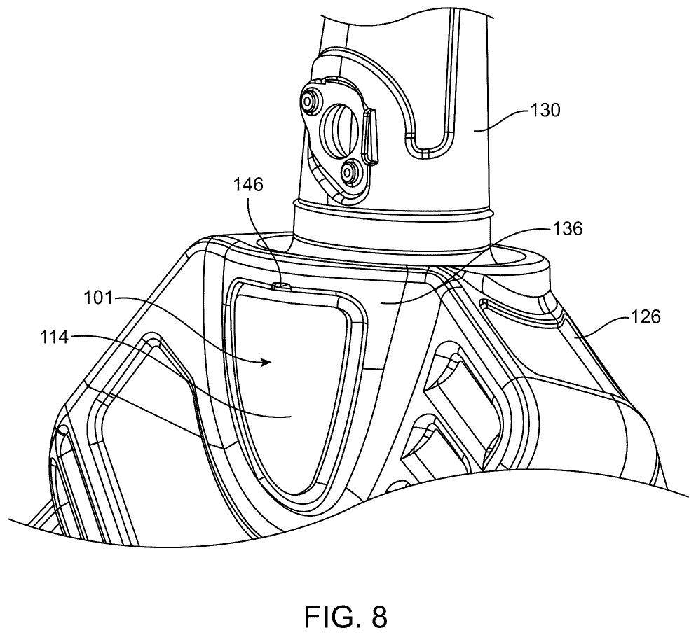

FIG. 8 is a perspective view of the assembled air intake system 120. As discussed above, the outer surface 114 of the window assembly 114 is flush with the outer surface 136 of the airbox 126 proximal to the aperture. Aperture notch 146 formed in the airbox 126 facilitates the removal of the window assembly 101 from the airbox 126.

Although the invention has been discussed with reference to specific embodiments, it is apparent and should be understood that the concept can be otherwise embodied to achieve the advantages discussed. The preferred embodiments above have been described primarily as an air intake system having a transparent, removable window assembly for viewing the air filter. In this regard, the foregoing description of the air intake system is presented for purposes of illustration and description. It shall be apparent that other types of equipment would benefit from the aspects of the air intake system.

Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

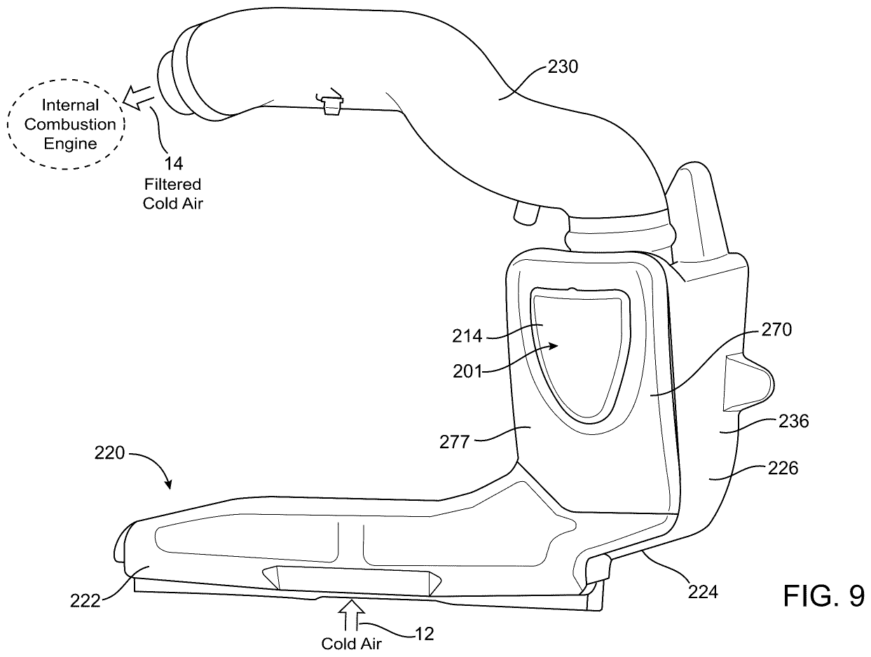

Referring now to FIGS. 9-16, embodiments of an air intake system comprising (1) an airbox, (2) an airbox cover (or “lid”) which releasably detaches from the airbox, and (3) a removable window assembly which releasably detaches from the airbox cover will now be described.

As discussed above, conventional automotive air intake systems often do not facilitate the convenient inspection or replacement of air filters from air filter housing boxes. Many conventional air intake systems fully enclose the air filter, which requires the user to disassemble the air filter housing box or the air intake system to inspect or replace the air filter, which is time-consuming and inconvenient.

As described herein, embodiments are directed to an airbox having a detachable airbox cover for accessing and replacing the air filter. Attached to the airbox cover is a removable window assembly for viewing the air filter. In a preferred embodiment, (1) the removable window assembly is magnetically coupled or attached to the airbox cover and (2) the airbox cover is magnetically coupled or attached to the airbox.

Embodiments described herein may exhibit the following useful properties. First, the user may view the air filter through the window assembly to determine whether replacement or cleaning of the filter is necessary. This is in contrast for many conventional air filter housings which would require the user to disassemble the air filter housing.

Second, the user may remove the window assembly from the airbox cover to gain an unobstructed view of the air filter.

Third, if a user needs to replace the automotive air filter, the user may then simply remove the airbox cover from the airbox to gain access to the air filter.

FIG. 9 is a perspective view of an air intake system 220 for an internal combustion engine 10 in one or more embodiments. The air intake system 220 comprises a cold air intake 222 for receiving cold air 12, an intake air duct 224, an airbox 226, a removable airbox cover 270 which detaches from the airbox 226, a removable window assembly 201 that detaches from the airbox cover 270, and a tube 230 for directing the filtered air 14 to an internal combustion engine 10. In an embodiment, the air intake system 220 is an aftermarket product.

The cold air intake 222 may be positioned near the grill of a vehicle (not shown), distal from the engine 10, to collect cooler air 12 from outside the vehicle. Hence, cold air 12 is collected by the cold air intake 222, passes through the cold air intake duct 224, enters the airbox 226, and then passes through the air filter 128 where air contaminants are removed from the cold air 12. The cold air is routed through the tube 230 where the filtered air 14 is fed into the internal combustion engine 10.

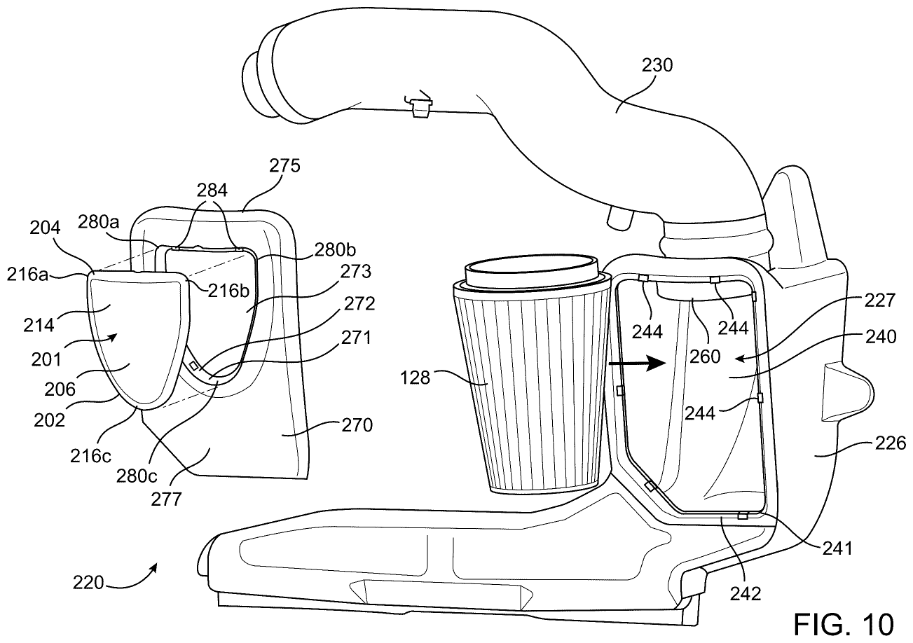

FIGS. 10-13 are perspective views of a partially disassembled air intake system 220 in one or more embodiments. As shown in FIG. 10, the detached airbox cover 270 reveals that air filter 128 is accessible and retrievable from the airbox aperture 240 of the airbox 226. The air filter 128 is held within the inner cavity 227 of the airbox 226, which is nestled against the velocity stack 260 of the airbox 226.

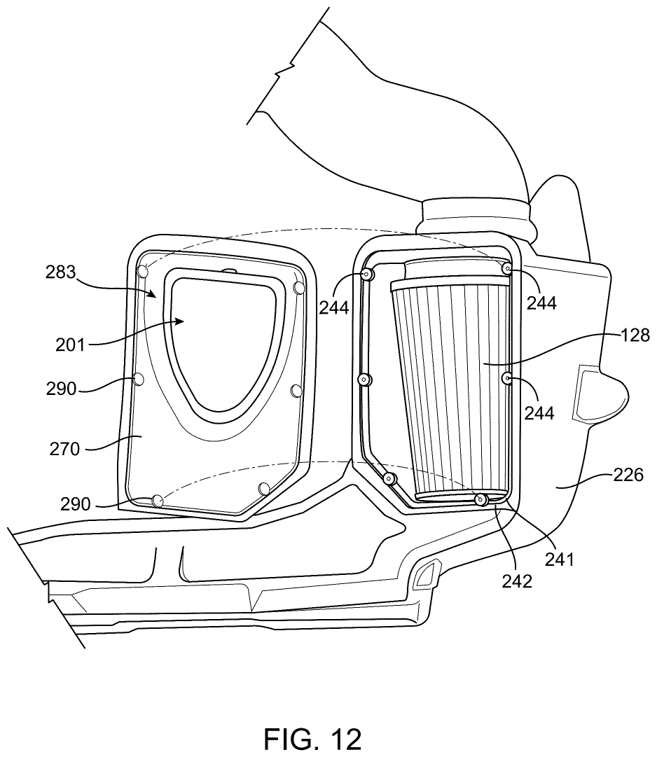

The airbox 226 has a recess 242 along the aperture perimeter 241 of the airbox 226 which is shaped to receive the airbox cover 270. The airbox cover 270 is magnetically coupled to the airbox 226. In an embodiment, airbox magnetic material 244 (which may be in the form of discrete clips, plugs, or strips made of magnetics or metals such as iron) are placed along the aperture perimeter 241. The airbox magnetic material 244 is positioned to align with lower airbox magnetic material 290 (see FIG. 12) formed on the airbox cover 270.

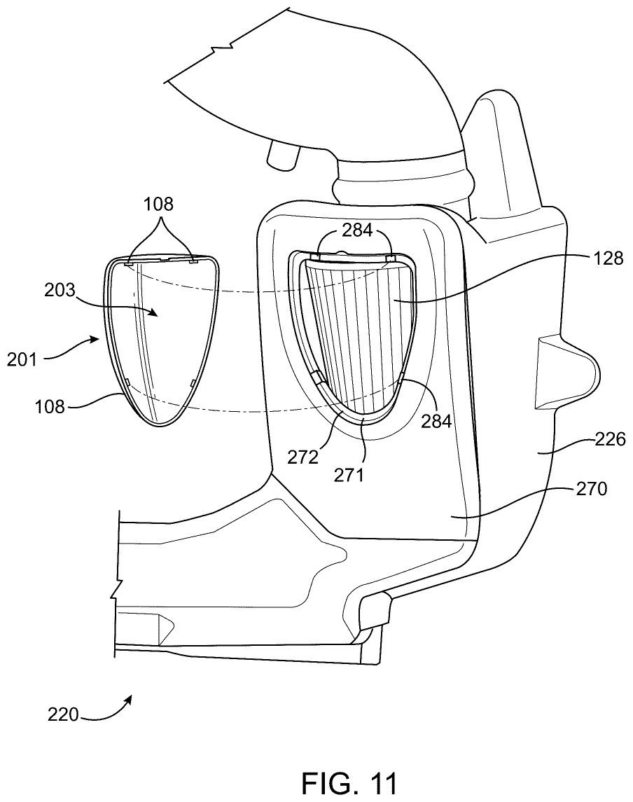

The airbox cover (or “lid”) 270 has an airbox cover aperture 273 that is shaped as an isosceles triangle having radiused corners 280a, 280b, and 280c and is adapted to receive the window assembly 201. A recess 272 is formed along the perimeter 271 of the airbox cover aperture 273 that is shaped to receive the window assembly 201. In a preferred embodiment, the airbox cover aperture 273 is positioned near a top 275 of the airbox cover 270 proximal to the tube 230 for directing filtered air to the internal combustion engine 10. Along a perimeter 271 of the airbox cover aperture 273, upper airbox cover magnetic material 284 is placed and positioned to align with the window assembly magnetic material 108 formed on the back 203 of the window assembly 201 (see FIG. 11).

As illustrated in FIG. 10, the removable window assembly 201 comprises a window housing 202 having a window frame 204 and a transparent window 206. The window housing 202 is shaped as an isosceles triangle having radiused corners 216a, 216b, and 216c.

As illustrated in FIG. 9, when the air intake system 220 is fully assembled, the airbox 226, airbox cover 270, and the window assembly 201 are contoured so that the outer surfaces of each of the components (i.e., the airbox 226, airbox cover 270, and the window assembly 201) are flush with each other. In a preferred embodiment, the airbox recess 242 is shaped to receive and surround the removable airbox cover 270 such that the outer surface 277 of the removable airbox cover 270 is generally flush with the outer surface 236 of the airbox 226. Likewise, the removable airbox cover 270 further comprises a cover recess 242 surrounding the cover aperture 240, such that the cover recess 242 is shaped to receive and surround the removable window assembly 201 such that the outer surface 214 of the removable window assembly 201 is generally flush with the outer surface 277 of the removable airbox cover 270.

As discussed above, the window assembly 201 is magnetically coupled or attached to the airbox cover 270, and the airbox cover 270 is magnetically coupled or attached to the airbox 226. As used herein, magnetic material (e.g., window assembly magnetic material 180, upper airbox cover magnetic material 284, lower airbox magnetic material 290, and airbox magnetic material 244) may be in the form of discrete clips, plugs, or strips made of magnetics or material attracted to magnets such as iron. Magnetic coupling requires two differing types of materials magnetically attracted to each other for both the attachment of the window assembly 201 to the airbox cover 270 as well as between the airbox cover to the airbox 226. Metal or metal alloys containing iron, cobalt, and nickel for example are attracted to magnetic fields sufficiently strong to be considered magnetic. Magnets are objects that produce a magnetic field that can attract some metal or metal alloys, or attract other magnets. As can be appreciated, there are various combinations of magnetized materials that can be employed to produce a fastening means through magnetism, such as combinations or metal to magnets, such as a magnet having a North or South pole to another magnet having a South or Noth pole respectively.

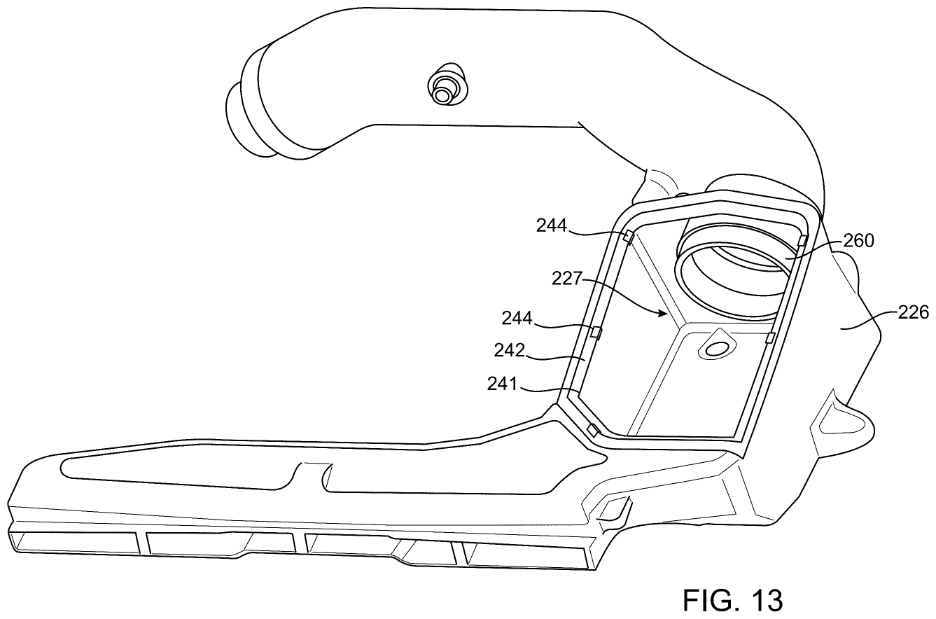

FIG. 11 is a perspective view of a partially disassembled air intake system 220 showing the back surface 203 of the removable window assembly 201 detached from the airbox cover 270. FIG. 12 is a perspective view of a partially disassembled air intake system 220 showing the back surface 283 of the removable airbox cover 270 detached from the airbox 220. FIG. 13 is a perspective view of the airbox 226 revealing the inner cavity 227 of the airbox 226.

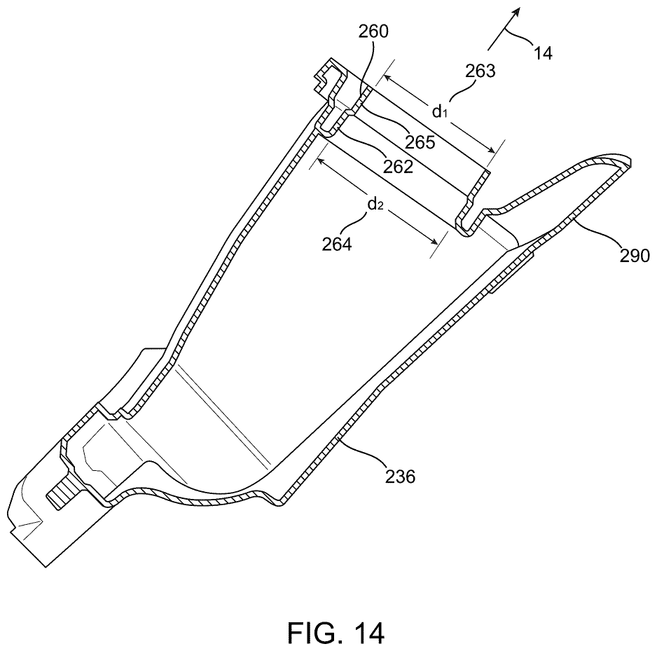

FIG. 14 is a cross-sectional view of the airbox 226. In a preferred embodiment, airbox 226 further comprises an internal velocity stack 260 leading to the tube 230 for directing filtered air 14 to the internal combustion engine 10. A velocity stack is a component employed to optimize airflow for engines. The velocity stack, sometimes shaped as a bell of a trumpet, is typically a tubular component having a decreasing inner diameter in the direction of air flow. The contour of the velocity stack effectively decreases turbulence and streamlines the intake air for an engine which leads to increased engine power and efficiency.

In the present preferred embodiment, the velocity stack 260 is formed proximally to the tube 230 for directing the filtered air 14 to an internal combustion engine and comprises a first aperture 262 and a second aperture 265. The velocity stack 260 is characterized by two apertures, first aperture 262 and second aperture 265, where the second aperture 265 has a smaller diameter. Specifically, the first aperture 262 has a diameter d2 and the second aperture 265 has a diameter d1, where d1 is less than d2 (d1<d2).

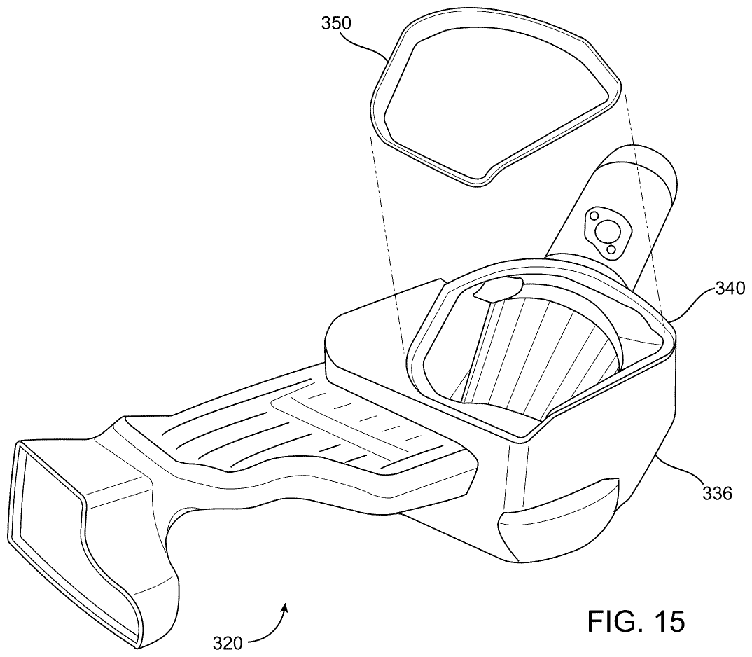

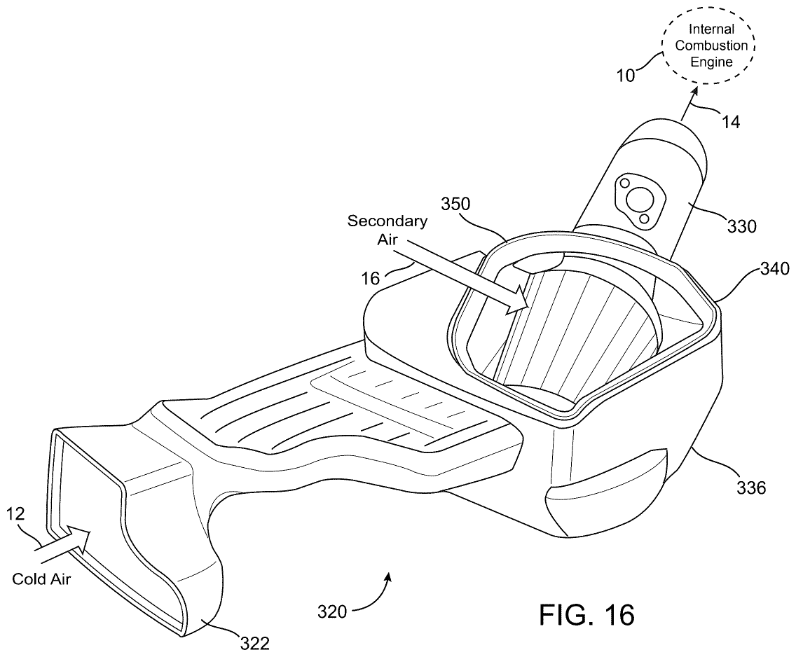

FIGS. 15-16 are perspective views of a dissembled airbox 336 in which the airbox cover 270 and the window assembly 201 are removed. As discussed above, many car enthusiasts may choose to remove the airbox cover 270 and the window assembly 201 to improve engine performance in terms of increased horsepower, torque, and fuel efficiency. In addition to enhanced engine performance, the removal of the airbox cover 270 and window assembly 201 may cause the cars to emit a unique sound resulting from the cold air rushing into the engines, which many users enjoy.

FIG. 15 is a perspective view of an airbox 340 where the airbox cover 270 and the window assembly 201 have been removed. FIG. 16 is a perspective view of the airbox 340 attached to the trim-piece 350 in one or more embodiments. A trim-piece 350 is shaped to attach to the perimeter 340 of the airbox 336, which can be releasably attached to the airbox 340. In an embodiment, a user may choose to remove the airbox cover 270 and the window assembly 201 to allow additional secondary airflow 16 into the filter to improve engine performance.

In a preferred embodiment, the air intake system 320 for the internal combustion engine 10 comprises a cold air intake 322 for receiving cold air 12, a tube 330 for directing filtered air 12 to an internal combustion engine 10, and an airbox 326, the airbox 326 configured to accept cold air 12 from the cold air intake 322, direct the air 12 though a filter 128, and provide filtered air 14 through the tube 330 leading to the internal combustion engine 10. The air intake system 320 further comprises an airbox aperture trim-piece 350 configured to releasably attach to the air box aperture 340 of the air box 226, the airbox aperture trim-piece 350 having an opening to receive secondary air 16 and direct the secondary air 16 through the air filter 128.

To briefly summarize one or more embodiments presented above, an air intake system 220 for an internal combustion engine 10 is contemplated. The air intake system 220 comprises a cold air intake 222 for receiving cold air 12, a tube 230 for directing filtered air 14 to an internal combustion engine and an airbox 226.

The airbox 226 has an airbox aperture 240 which is adapted to receive and releasably secure a conically-tapered automotive air filter 128. The airbox 226 is configured to accept cold air 12 from the cold air intake 222, direct the air 12 though the filter 128, and provide filtered air 14 through the tube 230 leading to the internal combustion engine 10. The airbox 226 is adapted to receive the automotive air filter 128 through the airbox aperture 240.

The air intake system 220 further comprises a removable airbox cover 270 having a cover aperture 273. The removable airbox cover 270 is configured to be received by and releasably attach to the airbox aperture 240 of the airbox 226.

The air intake system 220 further comprises a removable window assembly 201 configured to be received by and releasably attach to the cover aperture 240 of the removable airbox cover 270. The window assembly 201 comprises a window housing 202 comprising a window frame 204 and a transparent window 206. The window frame 204 surrounds the transparent window 206.

In a preferred embodiment both (1) the removable window assembly 201 is magnetically coupled or attached to the airbox cover 270 and (2) the airbox cover 270 is magnetically coupled or attached to the airbox 226. With respect to the magnetic coupling of the window assembly 210 and airbox cover 270, a window assembly magnetic material 180 is secured to the window frame 204 of the window assembly 201. A front cover magnetic material 284 is placed on the airbox cover 270 and is secured proximal to a perimeter 271 of the cover aperture 240 of the airbox cover 270. The window assembly magnetic material 180 on the window assembly 201 is magnetically attracted to the upper airbox cover magnetic material 284 of the airbox cover 270.

With respect to the magnetic coupling of the airbox cover 270 and the airbox 226, a lower airbox magnetic material 290 is secured to perimeter of the airbox cover 270. An airbox magnetic material 244 is secured proximal to the perimeter 241 of the airbox aperture 241 of the airbox 226. The lower airbox magnetic material 290 is magnetically attracted to the airbox magnetic material 244.

Although the invention has been discussed with reference to specific embodiments, it is apparent and should be understood that the concept can be otherwise embodied to achieve the advantages discussed. The preferred embodiments above have been described primarily as an air intake system having a detachable window assembly for viewing an air filter as well as an airbox cover for accessing the air filter. In this regard, the foregoing description of the air intake system is presented for purposes of illustration and description. It shall be apparent that other types of equipment would benefit from the aspects of the air intake system.

Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. An air intake system for an internal combustion engine, the air intake system comprising:
a cold air intake for receiving cold air;
a tube for directing filtered air to an internal combustion engine;
an airbox having an airbox aperture, the airbox adapted to receive and releasably secure an automotive air filter, the airbox configured to accept cold air from the cold air intake, direct the air though the filter, and provide filtered air through the tube leading to the internal combustion engine;
a removable airbox cover having a cover aperture, the removable airbox cover configured to be received by and releasably attach to the airbox aperture of the airbox; and,
a removable window assembly configured to be received by and releasably attach to the cover aperture of the removable airbox cover.

2. The air intake system for the internal combustion engine of claim 1, wherein the airbox is adapted to receive the automotive air filter through the airbox aperture.

3. The air intake system for the internal combustion engine of claim 1, wherein the airbox further comprises an internal velocity stack leading to the tube for directing filtered air to the internal combustion engine.

4. The air intake system for the internal combustion engine of claim 1, wherein:
the window assembly further comprises:
a window housing comprising a window frame and a transparent window, the window frame surrounding the transparent window; and,
a window assembly magnetic material secured to the window frame; and,
the removable airbox cover further comprises:
an upper airbox cover magnetic material secured proximal to a perimeter of the cover aperture of the airbox cover, wherein the window assembly magnetic material is magnetically attracted to the upper airbox cover magnetic material.

5. The air intake system for the internal combustion engine of claim 4, wherein:
the removable airbox cover further comprises:
a lower airbox magnetic material secured proximal to the perimeter of the removable cover;
the airbox further comprises:
airbox magnetic material secured proximal to the perimeter of the airbox aperture of the airbox, the lower airbox magnetic material of the removable cover is magnetically attracted to the airbox magnetic material of the airbox.

6. The air intake system for the internal combustion engine of claim 1, wherein the airbox further comprises an airbox recess surrounding the airbox aperture, the airbox recess is shaped to receive and surround the removable airbox cover such that the outer surface of the removable airbox cover is generally flush with outer surface of the airbox.

7. The air intake system for the internal combustion engine of claim 6, wherein the removable airbox cover further comprises a cover recess surrounding the cover aperture, the cover recess shaped to receive and surround the removable window assembly such that the outer surface of the removable window assembly is generally flush with the outer surface of the removable airbox cover.

8. The air intake system for the internal combustion engine of claim 1, wherein the airbox cover aperture is positioned near a top of the airbox cover proximal to the tube for directing filtered air to the internal combustion engine.

9. The air intake system for the internal combustion engine of claim 1, wherein the removable cover and window assembly are shaped as isosceles triangles having radiused corners.

10. The air intake system for the internal combustion engine of claim 1, wherein the air intake system is an aftermarket product.

11. An air intake system for an internal combustion engine, the air intake system comprising:
a cold air intake for receiving cold air;
a tube for directing filtered air to an internal combustion engine; and,
an airbox having an airbox aperture, the airbox adapted to receive and releasably secure an automotive air filter, the airbox configured to accept cold air from the cold air intake, direct the air though a filter, and provide filtered air through the tube leading to the internal combustion engine.

12. The air intake system for the internal combustion engine of claim 11, further comprising an airbox aperture trim-piece configured to releasably attach to the air box aperture of the air box, the airbox aperture trim-piece having an opening to receive secondary air and direct the secondary air through the air filter.

13. The air intake system for the internal combustion engine of claim 12, further comprising:
a removable airbox cover having a cover aperture, the removable airbox cover configured to be received by and magnetically coupled to the airbox aperture of the airbox; and,
a removable window assembly comprising a window housing having a window frame and a transparent window, the window frame surrounding the transparent window, the removable window assembly configured to be received by and magnetically coupled to the cover aperture of the removable airbox cover.

14. The air intake system for the internal combustion engine of claim 13, wherein the airbox is adapted to receive the automotive air filter through the airbox aperture.

15. The air intake system for the internal combustion engine of claim 13, wherein the airbox further comprises an internal velocity stack leading to the tube for directing filtered air to the internal combustion engine.

16. The air intake system for the internal combustion engine of claim 13, wherein the airbox further comprises an airbox recess surrounding the airbox aperture, the airbox recess is shaped to receive and surround the removable airbox cover such that the outer surface of the removable airbox cover is generally flush with outer surface of the airbox.

17. The air intake system for the internal combustion engine of claim 16, wherein the removable airbox cover further comprises a cover recess surrounding the cover aperture, the cover recess shaped to receive and surround the removable window assembly such that the outer surface of the removable window assembly is generally flush with the outer surface of the removable airbox cover.

18. The air intake system for the internal combustion engine of claim 13, wherein the airbox aperture is positioned near a top of the airbox proximal to the tube for directing filtered air to the internal combustion engine.

19. The air intake system for the internal combustion engine of claim 13, wherein the air intake system is an aftermarket product.

20. An air intake system for an internal combustion engine, the air intake system comprising:
a cold air intake for receiving cold air;
a tube for directing filtered air to an internal combustion engine;
an airbox having an airbox aperture, the airbox adapted to receive and releasably secure a conically-tapered automotive air filter, the airbox configured to accept cold air from the cold air intake, direct the air though the filter, and provide filtered air through the tube leading to the internal combustion engine;
a removable airbox cover having a cover aperture, the removable airbox cover configured to be received by and releasably attach to the airbox aperture of the airbox; and,
a removable window assembly comprising a window housing having a window frame and a transparent window, the window frame surrounding the transparent window, the removable window assembly configured to be received by and releasably attached to the cover aperture of the removable airbox cover.
wherein:
the airbox further comprises an internal velocity stack leading to the tube for directing filtered air to the internal combustion engine, and
the airbox further comprises an airbox recess surrounding the airbox aperture, the airbox recess is shaped to receive and surround the removable airbox cover such that the outer surface of the removable airbox cover is generally flush with the airbox, and
the removable airbox cover further comprises a cover recess surrounding the cover aperture, the cover recess shaped to receive and surround the removable window assembly such that the outer surface of the removable window assembly is generally flush with the removable airbox cover.
